(19) United States
(12) Patent Application Publication
(10) Pub. No.: US 2006/0056282 A1
(43) Pub. Date: Mar. 16, 2006

(54) Method of scheduling and forward link resource allocation in OFDM systems

(76) Inventors: Suman Das, Scotch Plains, NJ (US); Harish Viswanathan, Basking Ridge, NJ (US)

Correspondence Address: Lucent Technologies Inc;Docket Administrator - Room 3J-219, 101 Crawfords Corner Road, Holmdel, NJ, 07733-3030, US

(21) Appl. No.: 10/939,719

(22) Filed: Sep. 13, 2004

(51) Int. Cl. H04J 11/00; H04B 7/212

(52) U.S. Cl. 370/208; 370/442; 370/480

(57) ABSTRACT

A method of bandwidth allocation is provided for the forward link of an OFDM wireless communication system. Bandwidth is allocated to users in discrete blocks, but variable numbers of blocks are allocated to individual users. Multiple users can be served in one timeslot. The allocation is advantageously subjected to a power constraint and carried out in such a way as to drive up a figure of merit such as total throughput. In specific embodiments of the invention, power allocations to the different assigned blocks of bandwidth may vary in size.

### FIELD OF THE INVENTION

This invention relates to the scheduling and control of forward-link transmissions in OFDM systems.

### ART BACKGROUND

The signal quality received at a mobile station of a wireless system due to a forward-link transmission depends, among other things, on the propagation coefficient, or gain, hₙ^{k} from the base station to the mobile station. Here, the index k identifies a particular mobile station, also referred to as a user, and the index n identifies a particular frequency range.

It is well known that fluctuations of the propagation coefficients due to fading can affect the throughput of the wireless system. Forward-link schedulers have been devised, which improve the throughput by favoring those users which, within a given timeslot, have the highest gains. More specifically, a so-called weighted proportional scheduler will, in each timeslot, schedule a transmission to that user for which an expression of the form

$${w}_{k} log ( 1 + p \frac{{\vert {h}_{n}^{k} \vert}^{2}}{{N}_{0}} ) ,$$

or the like, is maximal. In the preceding expression, p is the forward link transmission power to each user, N₀ is a noise power level, and n designates the frequency subchannel, if any, specifically assigned to user k.

One use of the weights wₖ that are assigned to respective users is to achieve “fairness,” that is, to prevent a few nearby users from monopolizing the forward-link transmissions from the base station. Various algorithms are known for computing these weights in such a way that even the most distant users receive some share of the forward-link transmissions. Algorithms are also known for adjusting the weights in order to achieve other objectives, such as providing specific quality of service that has been contracted for, or assuring that the queue lengths associated with the busiest users do not grow excessively.

A common assumption that underlies forward-link scheduling is that fading is independent of frequency. Although such assumptions of “flat” fading lead to approximations that are useful at least over limited frequency ranges, there are further gains in throughput that can be achieved if the frequency dependence of fading is explicitly recognized.

### SUMMARY OF THE INVENTION

In OFDM systems, specific narrow frequency bands, referred to as “tones,” can be assigned for forward-link transmissions to specific users. We have found that when the frequency dependence of fading is taken into account, tones can be allocated to users in such a way as to achieve hitherto unrealized improvements in throughput.

Accordingly, the invention involves a method of bandwidth allocation for at least one timeslot of an OFDM forward link. In accordance with such method, bandwidth is allocated to one or more users in discrete blocks, but variable numbers of such blocks are allocated to individual users. A block may have as few as one tone, or it may comprise a plurality of contiguous or non-contiguous tones. The assignment of a particular subchannel to a particular user does not necessarily disqualify the user from receiving further subchannel assignments in the same timeslot. Moreover, the assignment of a particular subchannel to a particular user does not necessarily exclude the assignment of other subchannels to other users for transmission during the same timeslot.

The bandwidth allocation is advantageously subjected to a power constraint and carried out in such a way as to drive up a figure of merit, such as total throughput, or total throughput as modified by a weighting scheme.

In specific embodiments of the invention, power allocations to the different assigned blocks of bandwidth may vary in size.

### BRIEF DESCRIPTION OF THE DRAWING

FIG. 1 is a conceptual OFDM frequency spectrum, showing a grouping of subcarriers, or tones, into blocks of bandwidth referred to here as subchannels.

FIG. 2 is a conceptual block diagram showing illustrative steps of processing a signal for transmission.

FIG. 3 is a conceptual block diagram illustrating a procedure for selecting a single user to which to transmit during a given timeslot, and for allocating the total available transmit power among subchannels.

FIGS. 4 and 5 are conceptual block diagrams illustrating procedures for allocating transmit power and subchannels among a plurality of users for transmission in a given timeslot.

### DETAILED DESCRIPTION

As is well known, OFDM systems provide a plurality of frequency subcarriers, also referred to as “tones,” for use in downlink transmission. Several such tones are indicated in FIG. 1 by the reference numeral 10.

In accordance with the present invention, bandwidth may be allocated to users at the level of individual tones, or it may be allocated at a higher level of aggregation. We refer to an allocable block of one or more tones as a “subchannel.” In the illustrative embodiment to be described below, bandwidth is allocated in subchannels that comprise groups of tones. The tones that constitute such a subchannel may be arranged in a single contiguous block, or they may be partially contiguous or non-contiguous. The number of tones in a contiguous subchannel, or more generally, the total spectral range spanned by a subchannel, is advantageously selected such that to an approximation that is acceptable in practice, fading can be assumed flat across the subchannel. Several illustrative contiguous subchannels are indicated by the reference numeral 20 in FIG. 1, and an illustrative non-contiguous, subchannel is indicated in the figure by the reference numeral 21.

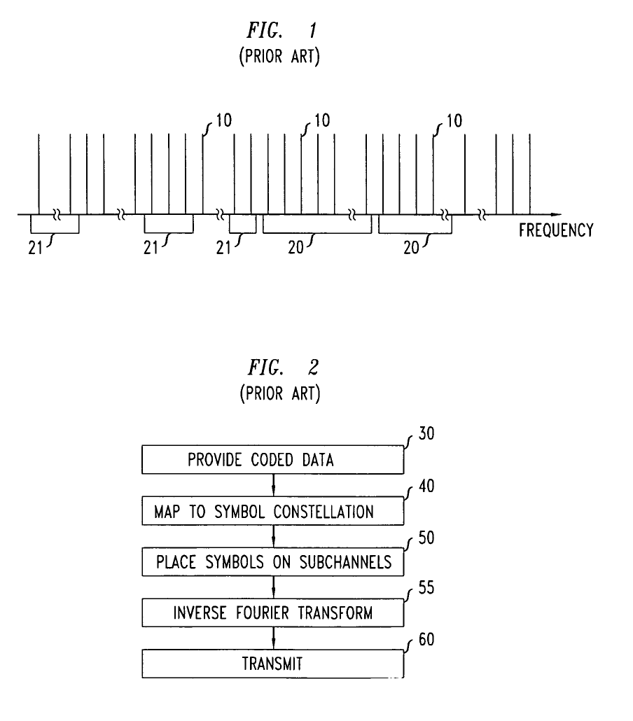

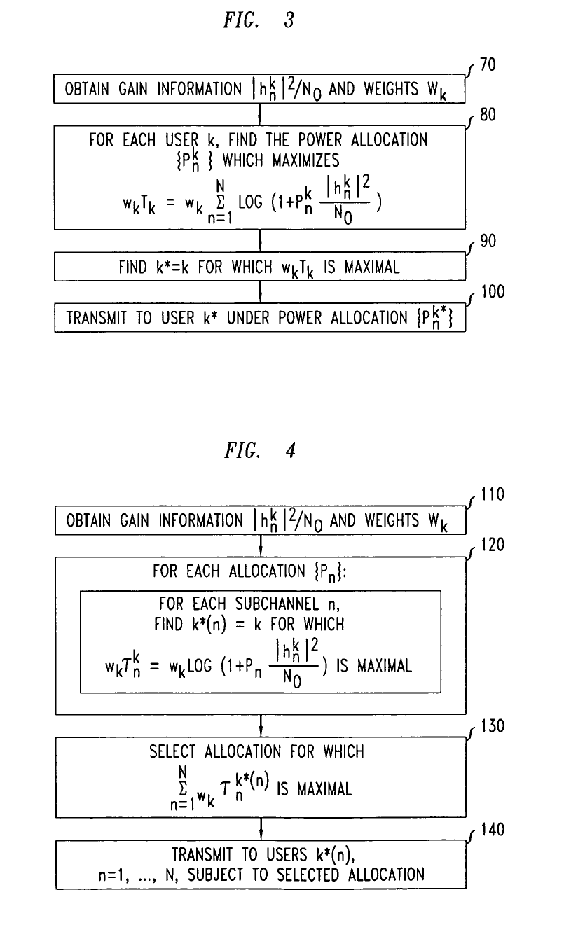

According to the exemplary processing sequence illustrated in FIG. 2, data to be transmitted are initially provided as a binary bit stream, which has optionally been subjected to a forward error-correcting coding process such as turbo coding. At block 30 of the figure, the coded data are provided for further processing. Well-known methods are used to map (block 40) the coded bits to a symbol constellation, and place the mapped symbols on subchannels (block 50). The data are then subjected (block 55) to an inverse Fourier transform process according to well-known methods of OFDM modulation, and transmitted, as indicated by block 60.

Forward-link transmissions are scheduled once per timeslot. Each timeslot typically contains several OFDM symbols. A given user will be assigned zero, one, or more than one subchannel for the entire duration of the timeslot.

Well-known design methods can be used to determine system parameters such as the frequency spacing between tones, the number of tones in each subchannel, the total number of subchannels, and the number of OFDM symbols transmitted in each timeslot. These parameters depend upon the system bandwidth, the delay spread, and the Doppler of the operating environment.

By way of example, an illustrative 5-MHz system has 10 microseconds of mean delay spread and up to 200 Hz of Doppler. In such a system, a FFT size of 512 can be selected, leading to a spacing of 9.80 kHz between tones. With sampling at 5 MHz, up to 60 samples can be assigned for cyclic prefix. This corresponds to an overhead of about 15%. The 512 tones can be grouped, e.g., into four contiguous subchannels of 128 tones each, or eight contiguous subchannels of 64 tones each.

The base station must acquire estimates of the forward channel. These estimates can be obtained from feedback data provided by the individual users, or measured directly from reverse pilot transmissions in TDD systems, or estimated from reverse pilot transmissions in FDD systems.

FIG. 3 illustrates a method of bandwidth allocation and scheduling in which forward transmissions are scheduled for only one user in each timeslot. As indicated at block 70, information about the gains hₙ^{k} on the forward channel to each user k in each subchannel n is obtained from the channel-estimation procedure. The gain information thus obtained is typically the squared magnitude |hₙ^{k}| of the gain, normalized to the noise power N₀, i.e.,

$$\frac{{\vert {h}_{n}^{k} \vert}^{2}}{{N}_{0}} .$$

If relevant, the weights wₖ are obtained from a scheduler. The object of the method illustrated in FIG. 3 is, in a joint optimization process, to select a single user and to allocate the available transmit power among subchannels for transmission to that user, in such a way that throughput in the pertinent timeslot is maximized. For clarity of presentation only, and not for purposes of limitation, the joint optimization process has been illustrated in FIG. 3 as including separate steps of finding (block 80) an optimal power allocation for each user, and selecting (block 90) that user for which the throughput is optimized.

We suppose that there are a total of K users and N subchannels. We use the symbol Pₙ^{k} to denote the transmit power to the k'th user in the n'th subchannel in a given timeslot.

For a given user k=k*, the quantity to be optimized by the power allocation is the total of the throughputs in each individual subchannel. The throughput in any given subchannel will depend upon the amount of transmit power allocated to that subchannel. The total amount of transmit power, summed over all subchannels, is not permitted to exceed a maximum amount P. The value P may be determined solely by system parameters, or it may be made responsive to traffic load by reducing it when there is relatively little data to be transmitted.

Typically, and as indicated in FIG. 3, the total power will equal P; that is, a partition {Pₙ^{k}*} will be imposed such that

$${\sum }_{n = 1}^{N} {P}_{n}^{{k}^{*}} = P .$$

Using, e.g., the Shannon formula for transmission rate for given transmit power and channel gain, and taking into account the weights wₖ, the power-allocation problem may be thought of as the problem of finding that power allocation that maximizes the product of the weight wₖ with the total throughput figure Tₖ, which we have defined by

$${T}_{k} = {\sum }_{n = 1}^{N} log ( 1 + {P}_{n}^{k} \frac{{\vert {h}_{n}^{k} \vert}^{2}}{{N}_{0}} ) .$$

This problem is illustrated at box 80 of FIG. 3. It should be noted that the use here of the Shannon formula is merely illustrative and not intended to be limiting. As will be appreciated by those skilled in the art, other formulas, based on other information-theoretic models, can be substituted without deviating from the general principles described here.

As indicated at box 90 of FIG. 3, the optimization problem is fully solved by selecting that user k* for which the weighted throughput wₖTₖ (under the maximizing power allocation) is maximal.

As indicated at block 100, transmission is made in the pertinent timeslot only to user k*, and only in those subchannels that are allocated transmit power under the optimizing power allocation. Although power can be allocated as a continuous quantity, it will generally be advantageous to allocate it in discrete steps, and to impose a minimum level such that each subchannel is allocated at least the minimum power level or else is allocated zero power.

Mathematically, the optimization problem of blocks 80 and 90 (neglecting the weights wₖ) is stated by:

$${k}^{*} = \text{arg} {max}_{k} {\sum }_{n = 1}^{N} log ( 1 + {P}_{n}^{k} \frac{{\vert {h}_{n}^{k} \vert}^{2}}{{N}_{0}} ) , \text{subject} \text{to} {\sum }_{n = 1}^{N} {P}_{n}^{k} \leq P .$$

One method that is readily used to solve the optimization problem of blocks 80 and 90 is the well-known water filling algorithm. In accordance with that algorithm, each power allocation Pₙ^{k} is determined from the expression

$${P}_{n}^{k} = {( \frac{1}{λ} - \frac{{N}_{0}}{{\vert {h}_{n}^{k} \vert}^{2}} )}^{+} ,$$

wherein λ is a Lagrange parameter chosen to solve the power constraint such that total allocated power equals P, and [L ]⁺ indicates that the bracketed quantity should be replaced by “0” if it is negative in value.

The method described above employs a single-user strategy; that is, only one user can be scheduled in each timeslot. By contrast, we have developed a new method which employs a multiple-user strategy. That is, our method permits any user that currently has at least one good subchannel to be a candidate for transmission, regardless of how many other users are also scheduled for transmission in the current timeslot. There is flexibility both in the number of users to be selected for transmission in a given timeslot, and the number of subchannels to be allocated to each respective user. In general, such a multiple-user strategy will achieve higher average throughputs than the single-user strategy described above. The multiple-user strategy incurs a modest cost in terms of some additional complexity required for the transmitter to identify which user has been allocated each subchannel. Such identification will typically be carried out through the control channel.

As illustrated in FIG. 4, the multiple-user strategy may be envisaged as obtaining (block 110) the gain information and weights; solving (block 120) a bandwidth allocation problem subject, in turn, to each of the possible power allocations; and selecting (block 130) an optimal power allocation. As indicated at block 140, transmission is made simultaneously to all users which have been allocated at least one subchannel of bandwidth, subject to the optimal power allocation. The division of the optimization problem into a bandwidth-allocation problem and a problem of selecting an optimal power allocation is made for clarity of presentation and not by way of limitation.

The partial optimization problem illustrated at block 120 takes each possible allocation of transmit power in turn. For each given such power allocation, the object is to identify the optimal user of each (powered) subchannel and assign the identified user to that subchannel. The optimal user is that user which maximizes the weighted throughput on that subchannel. To denote the throughput due to user k on subchannel n, we have chosen the symbol τₘ^{k}, defined by

$${τ}_{n}^{k} = log ( 1 + {P}_{n} \frac{{\vert {h}_{n}^{k} \vert}^{2}}{{N}_{0}} ) ,$$

wherein Pₙ is the power allocated to subchannel n under the current power allocation.

In terms, e.g., of the Shannon formula referred to above, the problem to be solved for each power allocation at block 120 is: For each subchannel n, find that user, identified as user k*(n), for which wₖτₙ^{k} is maximal.

The partial optimization problem illustrated at block 130 is to select that power allocation for which the total weighted throughput, as summed over all (powered) subchannels, is maximal. It should be noted in this regard that some users may be counted more than once in such a summation, because more than one subchannel may be assigned to a given user. In other words, receiving a subchannel assignment does not disqualify a user from receiving further subchannel assignments, although an upper limit on the number of subchannels assigned to a single user in a given timeslot may readily be imposed. The comments made above in regard to FIG. 3 concerning the possibility that allocated power levels may be discrete and that a lower limit may be imposed on them apply equally to the method of FIG. 4.

Mathematically, the optimization problem of blocks 120 and 130 may be stated as:

$$\text{Optimum} \text{Weighted} \text{Throughput} = {max}_{\{ {P}_{n} \} : {\sum }_{n = 1}^{N} {P}_{n} \leq P} {\sum }_{n = 1}^{N} {max}_{k} {w}_{k} log ( 1 + {P}_{n} \frac{{\vert {h}_{n}^{k} \vert}^{2}}{{N}_{0}} ) ,$$

wherein Pₙ is the transmit power allocated to the n'th subchannel.

In the event that all weights are equal, the above optimization problem is readily solved by the generalized water-filling solution obtained by constructing a virtual channel with the best subchannel gains across all the users for each subchannel, and then water filling over the virtual channel.

In the event that the power allocation is made equal across all subchannels, i.e., Pₙ=P′=constant, the optimization problem reduces to the problem of optimizing the assignment of users to subchannels. Mathematically, such a problem may be stated by:

$$\text{Optimum} \text{Weighted} \text{Throughput} = {\sum }_{n = 1}^{N} {max}_{k} {w}_{k} log ( 1 + {P}^{′} \frac{{\vert {h}_{n}^{k} \vert}^{2}}{{N}_{0}} ) .$$

Such an optimization is readily solved in a straightforward fashion using known techniques, with complexity O(NK). More specifically, the solution need be no more complex than an exhaustive search over N subchannels (or N tones if there is only one tone per subchannel), with K operations per subchannel.

In at least some cases, it will be advantageous to allocate the total power equally across fewer than all the available channels. That is, a criterion is applied for selecting a variable number of subchannels that best satisfy the criterion. The total power is allocated equally across the selected subset of channels. Given the selected subset, the users are readily assigned to the selected subchannels by the procedure described above.

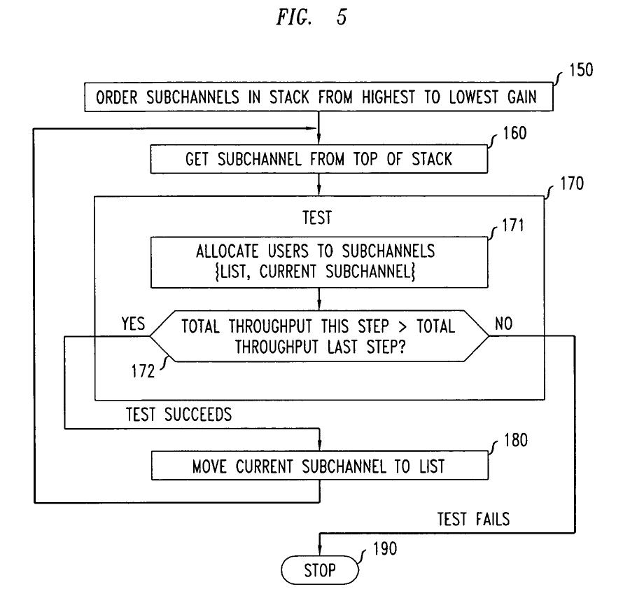

In one possible approach, illustrated in FIG. 5, the criterion for selecting subchannels is based on gain and throughput. The subchannels are arranged (block 150) in a stack such that from top to bottom they are in decreasing order by a figure of merit which is the maximum subchannel gain across all users. Then an (initially empty) list, here denominated “LIST”, of selected subchannels is filled in a sequence of steps. In each step, the subchannel currently at the top of the stack is accessed (block 160). A test (block 170) here denominated “TEST” is performed on the subchannel currently at the top of the stack. If TEST succeeds, the top subchannel is removed from the stack and placed in LIST (block 180). If TEST fails, the procedure terminates (block 190).

TEST is defined as follows: Carry out (block 171) the optimal allocation of users to subchannels according to the procedure described above, with equal allocation of total power. Carry out the procedure assuming that the only available subchannels are those currently in LIST and the subchannel currently at the top of the stack. Evaluate (block 172) the total throughput. If the total throughput is greater than it was in the previous step, TEST succeeds. Otherwise, TEST fails.

We have devised an approximate procedure for solving the general form of the optimization problem of blocks 120 and 130. Let i*(j) denote the index of the user that achieves maximum throughput in subchannelj in the optimal solution. Then the optimal power allocation must satisfy

$${P}_{j} ( λ ) = ( \frac{{w}_{{i}^{*}} ( j )}{λ} - \frac{{N}_{0}}{{\vert {h}_{j}^{{i}^{*} ( j )} \vert}^{2}} ) ,$$

where λ is a Lagrange parameter determined by the power constraint. Substituting the above expression into the expression for the Optimum Weighted Throughput yields the following reformulated objective:

$${max}_{λ} {\sum }_{j = 1}^{N} {max}_{i} {w}_{i} {\{ log ( \frac{{\vert {h}_{j}^{i} \vert}^{2} {w}_{i}}{λ} ) \}}^{+} , \text{subject} \text{to} {\sum }_{j = 1}^{N} {( \frac{{w}_{i}}{λ} - \frac{{N}_{0}}{{\vert {h}_{j}^{{i}^{*} ( j )} \vert}^{2}} )}^{+} = P .$$

We define the following functions:

$${f}_{j}^{i} ( λ ) B {w}_{i} {\{ log ( \frac{{w}_{i} {\vert {h}_{j}^{i} \vert}^{2}}{λ} ) \}}^{+}$$

$${f}_{j} ( λ ) B {max}_{i} {f}_{j}^{i} ( λ ) .$$

We note that fⱼ(λ) is a monotonically decreasing function of λ and that it is piecewise differentiable. The boundaries of the respective pieces can be determined by finding the intersections fⱼ^{s}(λⱼ^{s,t})=fⱼ^{t}(λⱼ^{s,t}) between all pairs of users (s,t). The solution λⱼ^{s,t} at each such intersection is given by:

$$log {λ}_{j}^{s , t} = \frac{{w}_{s} log ( {\vert {h}_{j}^{s} \vert}^{2} {w}_{s} ) - {w}_{t} log ( {\vert {h}_{j}^{t} \vert}^{2} {w}_{t} )}{{w}_{s} - {w}_{t}} .$$

The objective

$$f ( λ ) = {\sum }_{j = 1}^{N} {f}_{j} ( λ )$$

is also piecewise differentiable and monotonically decreasing with at most Ntimes as many pieces as fⱼ(λ). The power-constraint function is also piecewise differentiable and has the same boundaries. In each piece, a bisection over A can be used to determine the optimum solution in that piece. The overall solution can thus be determined by taking the maximum of the objective over the respective pieces. Since there are at most NK² intersection points, the number of bisection searches required is O(NK²). Because there will generally be only a few intersection points among the various users, the number of searches will, in practice, typically be smaller than this prediction.

What is claimed is:

1. A method of OFDM transmission, comprising:
for each of a plurality of timeslots, selecting one or more users, each of which is to receive a transmission during the timeslot;
assigning one or more subchannels to each selected user; and
transmitting in each of the allocated subchannels during the timeslot; wherein:
two or more subchannels are assigned;
each subchannel assignment comprises identifying a user for which throughput on that subchannel is relatively high, and giving the subchannel to that user;
the assignment of a particular subchannel to a particular user does not necessarily disqualify the user from receiving further subchannel assignments; and
the assignment of a particular subchannel to a particular user does not necessarily exclude the assignment of other subchannels to other users for transmission during the same timeslot.

2. The method of claim 1, further comprising allocating transmit power among the allocated subchannels such that different subchannels may be assigned different levels of transmit power.

3. The method of claim 2, wherein the allocation of subchannels and the allocation of transmit power are carried out so as to jointly maximize a measure of throughput.

4. The method of claim 1, wherein all available subchannels are assigned to users, and transmit power is allocated equally across the assigned subchannels.

5. The method of claim 1, wherein a selected subset of subchannels is assigned to users, and transmit power is allocated equally across the assigned subchannels.

6. The method of claim 1, wherein the measure of throughput is a weighted measure.
